(19) United States
(12) Patent Application Publication
(10) Pub. No.: US 2016/0377190 A1
(43) Pub. Date: Dec. 29, 2016

(54) ARMATURE ASSEMBLY AND VALVE CARTRIDGE FOR A SOLENOID VALVE, AND METHOD FOR INSTALLING AN ARMATURE ASSEMBLY

(71) Applicant: Robert Bosch GmbH, Stuttgart (DE)

(72) Inventor: Harald Speer, Freiberg (DE)

(21) Appl. No.: 15/192,248

(22) Filed: Jun. 24, 2016

(30) Foreign Application Priority Data
Jun. 25, 2015 (DE) 102015211799.5

(51) Int. Cl. F16K 31/06; F16K 25/00

(52) U.S. Cl. CPC F16K 31/0696; F16K 31/0655; F16K 25/005

(57) ABSTRACT

An armature assembly for a solenoid valve having a main body, which, at one end, receives a sealing element having a sealing geometry that cooperates with a valve seat and, at the other end, receives a return spring that is supported on a spring mount, as well as a valve cartridge for a solenoid valve, and a method for installing an armature assembly. Here, the sealing element is guided axially movably against the spring force of an elastic damping element in a through-extending axial recess of the main body, the elastic damping element being configured between the sealing element and the spring mount and damping an impulse generated in response to the sealing geometry striking the valve seat.

### CROSS REFERENCE

The present application claims the benefit under 35 U.S.C. §119 of German Patent Application No. DE 102015211799.5 filed on Jun. 25, 2015, which is expressly incorporated herein by reference in its entirety.

### FIELD

The present invention relates to an armature assembly for a solenoid valve, to a corresponding armature assembly for a solenoid valve, as well as to a method for installing an armature assembly.

### BACKGROUND INFORMATION

Normally open or normally closed solenoid valves are conventional. They are used as intake valves or exhaust valves in a hydraulic unit of a vehicle brake system, for example. Control and/or regulating processes may be carried out via the hydraulic unit in an anti-lock braking system (ABS), a traction control system (TCS system), or in an electronic stability program system (ESP system) for building up pressure, respectively for reducing pressure in corresponding brake calipers. Thus, the conventional solenoid valves produce what is commonly known as a closing noise, for example, when a sealing geometry configured as a spherical cap, for example, makes contact with a corresponding valve seat.

German Patent Application No. DE 10 2013 202 332 A1 describes a solenoid valve for a vehicle that includes a solenoid assembly and a valve cartridge. The valve cartridge includes a pole core, a receiving sleeve that is joined thereto, and an armature assembly, which is axially movably guided within the receiving sleeve against the force of a return spring between a closed position and an open position and which includes a sealing element having a sealing geometry. The receiving sleeve is also joined to a valve sleeve that includes a valve seat configured between at least a first flow orifice and at least a second flow orifice. In the closed position, the sealing geometry cooperates sealingly with the valve seat and interrupts a fluid flow between the at least one first flow orifice and the at least one second flow orifice. In the open position, the sealing geometry lifts off from the valve seat and allows the fluid to flow between the at least one first flow orifice and the at least one second flow orifice. The armature assembly includes a main body, which, at one end, at least partially receives the sealing element having the sealing geometry and, at the other end, a return that is supported on a spring mount.

### SUMMARY

It may be an advantage of the armature assembly for a solenoid valve in accordance with the present invention and of the corresponding valve cartridge for a solenoid valve in accordance with the present invention that the armature assembly is modified to reduce and, optimally, even completely prevent the closing noise that occurs during valve closing. The impulse generated in response to the sealing geometry striking the valve seat may be damped by using an elastic damping element between the sealing element and the spring mount, thereby making it possible to advantageously reduce the structure-borne sound in the system.

Thus, specific embodiments of the present invention contribute to improved NVH behavior (NVH: noise vibration harshness) of the vehicle by diminishing and, ideally, entirely avoiding the disturbing noises generated by the closing of the solenoid valve. The vehicle brake system may thereby be designed as a single-box system and the hydraulic unit bolted directly to the front bulkhead of the vehicle, since no disturbing closing noises are able to reach the passenger compartment.

It may be an advantage of the method for installing an armature assembly in accordance with the present invention that the costs for manufacturing the solenoid valve maybe significantly lowered, since the installation processes are eliminated, respectively since there is only one installation direction.

Specific embodiments of the present invention provide an armature assembly for a solenoid valve having a main body, which, at one end, receives a sealing element having a sealing geometry that cooperates with a valve seat and, at the other end, a return spring that is supported on a spring mount. The sealing element is guided axially movably against the spring force of an elastic damping element in a through-extending axial recess of the main body, the elastic damping element being configured between the sealing element and the spring mount and damping an impulse generated in response to the sealing geometry striking the valve seat.

Also provided is a valve cartridge for a solenoid valve having a pole core, a receiving sleeve joined thereto, an armature assembly of such a type that is guided axially movably within the receiving sleeve against the force of a return spring between a closed position and an open position that includes a sealing element having a sealing geometry, and a valve sleeve that is joined to the receiving sleeve and has a valve seat configured between at least one first flow orifice and at least one second flow orifice. In the closed position, the sealing geometry cooperates sealingly with the valve seat and interrupts a fluid flow between the at least one first flow orifice and the at least one second flow orifice. In the open position, the sealing geometry lifts off from the valve seat and allows the fluid to flow between the at least one first flow orifice and the at least one second flow orifice.

The example method according to the present invention for installing an armature assembly having a main body that features a through-extending axial recess, a sealing element, which has a stem and a sealing geometry that cooperates with a valve seat, a return spring, and a spring mount upon which the return spring is supported, includes the steps of: inserting the sealing element and the elastic damping element into a larger-diameter opening of the axial recess of the main body until a stop shoulder configured on the sealing element is braced against a taper edge of the axial recess formed as a limit stop, and the stem and the sealing geometry project from a smaller-diameter opening of the axial recess; pressing the spring mount to the correct position into the larger-diameter opening of the axial recess, a preload force of the elastic damping element being adjusted by the pressing in of the spring mount, and inserting the return spring into the larger-diameter opening of the axial recess until the return spring rests against the spring mount.

Advantageous improvements to the armature assembly for a solenoid valve in accordance with the present invention are made possible by the measures and refinements described below.

It may be especially advantageous that the damping element may be designed as an insert. This makes possible an especially simple and cost-effective design of the armature assembly for a solenoid valve.

One advantageous embodiment of the armature assembly provides for the damping element to be joined to the sealing element by a bonding process and/or a vulcanization process. The single piece design makes it possible to advantageously reduce the number of assembly parts.

Another advantageous embodiment of the armature assembly provides for designing the sealing element as a cylindrical plastic injection-molded part. Thus, the sealing element may preferably be fabricated from a thermoplastic plastic, such as from a polyether ether ketone (PEEK), for example. The sealing element may also be manufactured using a two-component technology, an elastic component of the sealing element being able to form the damping element. The plastic injection-molded part design advantageously makes it possible to enhance the inherent elasticity of the sealing element.

Another advantageous embodiment of the armature assembly provides for fabricating the elastic damping element from an elastomer. Over the entire width thereof, the elastic damping element may preferably be configured on an end face of the sealing element facing the spring mount.

Another aspect may provide that the sealing element feature a stem in a stepped design, the sealing geometry being configured at the thinner end of the stem. Here, the step may form a stop shoulder that may be braced against a taper edge of the axial recess configured as a limit stop. The stepped design of the sealing element stem makes it thinner in the region of the sealing geometry, thereby advantageously allowing a greater inherent elasticity in this area of the component.

An exemplary embodiment of the present invention is illustrated in the FIGURE and is explained in greater detail in the following description. In the FIGURE, identical reference numerals denote components or elements that perform the same or analogous functions.

### BRIEF DESCRIPTION OF THE DRAWING

FIG. 1 shows a schematic, cross-sectional view of an exemplary embodiment of a valve cartridge according to the present invention for a solenoid valve having an armature assembly according to the present invention.

### DETAILED DESCRIPTION OF EXAMPLE EMBODIMENTS

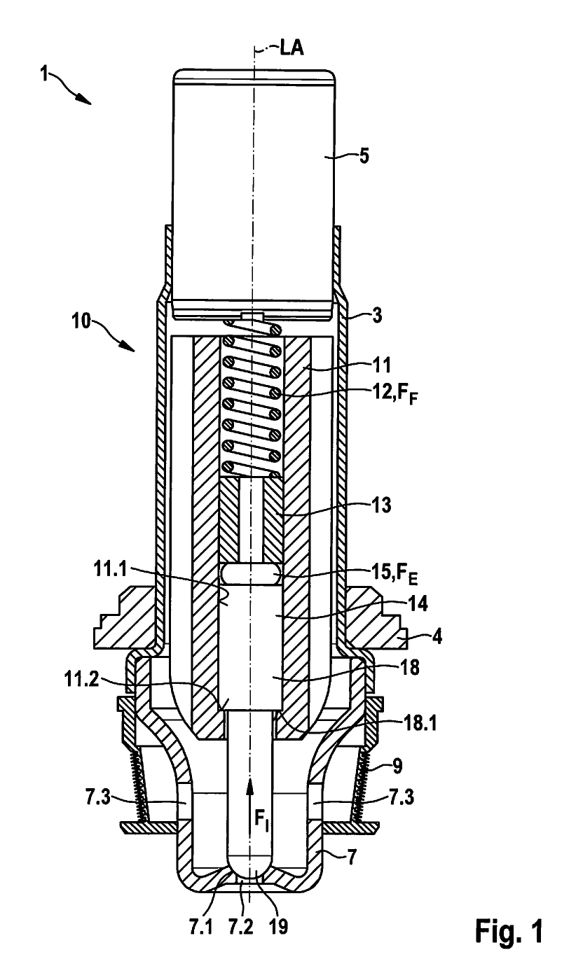

As is shown in FIG. 1, the illustrated exemplary embodiment of a valve cartridge 1 according to the present invention for a solenoid valve includes a pole core 5, a receiving sleeve 3 joined thereto, an armature assembly 10, which is guided axially movably within receiving sleeve 3 against the force of a return spring 12 between a closed position and an open position and which includes a sealing element 14 having a sealing geometry 19, and a valve sleeve 7 that is joined to receiving sleeve 3 and has a valve seat 7.1 configured between at least one first flow orifice 7.2 and at least one second flow orifice 7.3. In the closed position, sealing geometry 19 cooperates sealingly with valve seat 7.1 and interrupts a fluid flow between the at least one first flow orifice 7.2 and the at least one second flow orifice 7.3.

In the open position, sealing geometry 19 lifts off from valve seat 7.1 and allows the fluid to flow between the at least one first flow orifice 7.2 and the at least one second flow orifice 7.3.

As is shown in FIG. 1, the illustrated exemplary embodiment of armature assembly 10 for a solenoid valve includes a main body 11 which, at one end, receives sealing element 14 having sealing geometry 19 that cooperates with valve seat 7.1 and, at the other end, receives return spring 12 that is supported on a spring mount 13. Here, sealing element 14 is guided axially movably against spring force F_{E} of an elastic damping element 15 in a through-extending axial recess 11.1 of main body 11, elastic damping element 15 being configured between sealing element 14 and spring mount 13 and damping an impulse generated in response to sealing geometry 19 striking valve seat 7.1.

During a closing operation of the solenoid valve, an impulse force F₁ is generated in response to sealing geometry 19 striking valve seat 7.1. This is reduced because sealing element 14 is axially displaceable in axial recess 11.1 of main body 11 and is damped by elastic damping element 15. This is the case when impulse force F₁ is greater than preload force F_{E} of elastic damping element 15.

In response to an energization of a solenoid assembly (not specifically shown), i.e., in response to an electric current applied via electrical connections to a coil winding of the solenoid assembly, axially movable armature assembly 10 is moved by a magnetic force generated within receiving sleeve 3 against the force of return spring 12. The maximum possible stroke of armature assembly 10 is predetermined by an air gap between pole core 5 and main body 11 of armature assembly 10. As is also readily apparent from FIG. 1, in the illustrated closed position, sealing geometry 19 of sealing element 14 cooperates sealingly with valve seat 7.1 and interrupts a fluid flow between the at least one first flow orifice 7.2 and the at least one second flow orifice 7.3. In an open position (not specifically shown), sealing geometry 19 of sealing element 14 lifts off from valve seat 7.1 and allows the fluid to flow between the at least one first flow orifice 7.2 and the at least one second flow orifice 7.3.

As is also shown in FIG. 1, a valve bushing 4 may be used to stake valve cartridge 1 into a corresponding location bore of a fluid block (not specifically shown). To filter dirt particles out of the fluid flow, a radial filter 9 is also configured on the outside of valve sleeve 7 in the area of the at least one second flow orifice 7.3.

In the illustrated exemplary embodiment, damping element 15 is designed as an insert. Damping element 15 may alternatively be joined to sealing element 14 by a bonding process and/or a vulcanization process. Moreover, sealing element 14 may also be manufactured using a two-component technology, an elastic component of sealing element 14 forming damping element 15.

As is also shown in FIG. 1, in the illustrated exemplary embodiment, sealing element 14 is designed as a cylindrical plastic injection-molded part having a stepped stem 18. Elastic damping element 15 is fabricated from an elastomer and configured over the entire width thereof on an end face of sealing element 14 facing spring mount 13. Sealing geometry 19 is configured at the thinner end of stem 18. The step forms a stop shoulder 18.1 that is braced against a taper edge of axial recess 11.1 configured as a limit stop 11.2. Reducing the outer diameter of stem 18 achieves a greater inherent elasticity in this area of sealing element 14. A slight “excess resilience” of sealing element 14 may be advantageously damped by mounting elastic damping element 15 at the end face of the guide diameter of sealing element 14.

During installation of armature assembly 10, sealing element 14 and elastic damping element 15 are inserted into a larger-diameter opening of axial recess 11.1 of main body 11 until a stop shoulder 18.1 configured on sealing element 14 is braced against a taper edge of axial recess 11.1 formed as a limit stop 11.2, and stem 18 and sealing geometry 19 project from a smaller-diameter opening of axial recess 11.1. Spring mount 13 is then pressed to the correct position into the larger-diameter opening of axial recess 11.1, preload force F_{E} of elastic damping element 15 being adjusted by the pressing in of spring mount 13. Return spring 12 is subsequently inserted into the larger-diameter opening of axial recess 11.1 until it rests against spring mount 13. In the closed state of the solenoid valve, pressing in the spring mount to the correct position results in a preload force F_{F} of return spring 12 that is greater than preload force F_{E} of elastic damping element 15.

The costs for installing valve cartridge 1 of the solenoid valve may be significantly reduced by observing one direction of installation, as well as by eliminating the spring force adjustment.

The illustrated exemplary embodiment relates to a valve cartridge 1 for a normally closed solenoid valve. However, armature assembly 10 according to the present invention may also be used for a valve cartridge (not specifically shown) of a normally open solenoid valve in order to damp the closing noise.

By using an elastic damping element and an axially movable sealing element, specific embodiments of the present invention provide an armature assembly and a valve cartridge for a solenoid valve that advantageously damp the impulse generated in response to the sealing geometry striking the valve seat, and thereby reduce the structure-borne sound in the vehicle.

What is claimed is:

1. An armature assembly for a solenoid valve, comprising:
a main body, which, at one end, receives a sealing element having a sealing geometry that cooperates with a valve seat and, at the other end, receives a return spring that is supported on a spring mount;
wherein the sealing element is guided axially movably against the spring force of an elastic damping element in a through-extending axial recess of the main body, the elastic damping element being configured between the sealing element and the spring mount and damping an impulse generated in response to the sealing geometry striking the valve seat.

2. The armature assembly as recited in claim 1, wherein the elastic damping element is designed as an insert.

3. The armature assembly as recited in claim 1, wherein the elastic damping element is joined to the sealing element by at least one of a bonding process and a vulcanization process.

4. The armature assembly as recited in claim 1, wherein the sealing element is designed as a cylindrical plastic injection-molded part.

5. The armature assembly as recited in claim 4, wherein the sealing element is manufactured using a two-component technology, an elastic component of the sealing element forming the elastic damping element.

6. The armature assembly as recited in claim 1, wherein the elastic damping element is fabricated from an elastomer.

7. The armature assembly as recited in claim 1, wherein the elastic damping element is configured over an entire width thereof on an end face of the sealing element facing the spring mount.

8. The armature assembly as recited in claim 1, wherein the sealing element has a stem in a stepped design, the sealing geometry being configured at a thinner end of the stem, and the step forming a stop shoulder that is braced against a taper edge of an axial recess that is configured as a limit stop.

9. A valve cartridge for a solenoid valve, comprising:
a pole core;
a receiving sleeve joined to the pole core;
an armature assembly, which is guided axially movably within the receiving sleeve against a force of a return spring between a closed position and an open position and which includes a sealing element having a sealing geometry; and
a valve sleeve that is joined to the receiving sleeve and has a valve seat that is configured between at least one first flow orifice and at least one second flow orifice;
wherein in the closed position, the sealing geometry cooperating sealingly with the valve seat, and interrupting a fluid flow between the at least one first flow orifice and the at least one second flow orifice; and
wherein in an open position, the sealing geometry lifting off from the valve seat and allowing the fluid to flow between the at least one first flow orifice and the at least one second flow orifice; and
wherein the armature assembly includes a main body, which, at one end, receives the sealing element having a sealing geometry that cooperates with the valve seat and, at the other end, receives the return spring that is supported on a spring mount, and wherein the sealing element is guided axially movably against the spring force of an elastic damping element in a through-extending axial recess of the main body, the elastic damping element being configured between the sealing element and the spring mount and damping an impulse generated in response to the sealing geometry striking the valve seat.

10. A method for installing an armature assembly having a main body, which has a through-extending axial recess, a sealing element, which has a stem and a sealing geometry that cooperates with a valve seat, a return spring and a spring mount upon which the return spring is supported, the method comprising:
inserting the sealing element and an elastic damping element into a larger-diameter opening of the axial recess of the main body until a stop shoulder configured on the sealing element is braced against a taper edge of the axial recess formed as a limit stop, and the stem and the sealing geometry project from a smaller-diameter opening of the axial recess;
pressing the spring mount to the correct position into the larger-diameter opening of the axial recess, a preload force of the elastic damping element being adjusted by the pressing in of the spring mount; and
inserting the return spring into the larger-diameter opening of the axial recess until the return spring rests against the spring mount.
